(19) United States
(12) Patent Application Publication
(10) Pub. No.: US 2025/0050822 A1
(43) Pub. Date: Feb. 13, 2025

(54) VEHICLE ROOF HAVING AN OUTER ROOF SKIN ELEMENT AND HEADLINER

(71) Applicant: Webasto SE, Stockdorf (DE)

(72) Inventors: Andreas Josef ZUNZER, Stockdorf (DE); Enrico MÜNTEL, Stockdorf (DE); Michael ADAM, Stockdorf (DE)

(21) Appl. No.: 18/784,006

(22) Filed: Jul. 25, 2024

(30) Foreign Application Priority Data
Aug. 10, 2023 (DE) 10 2023 121 371.7

(51) Int. Cl. B60R 13/02; B60R 13/08

(52) U.S. Cl. CPC B60R 13/0212; B60R 13/0815

(57) ABSTRACT

A vehicle roof having a roof frame, an outer roof skin element and a headliner, which forms a visible surface visible from a vehicle interior. An acoustic seal fully bridges a gap between the outer roof skin element and the headliner.

### CROSS-REFERENCE TO RELATED APPLICATION(S)

This application claims the benefit of German patent application no. 10 2023 121 371.7 filed on Aug. 10, 2023, which is incorporated herein by reference in its entirety.

### TECHNICAL FIELD

This disclosure relates generally to a vehicle roof.

### BACKGROUND

A vehicle roof of this kind is known from practice and can be used in particular with a passenger car and can be designed in such a modular way that it can be connected as a unit to a vehicle body or a vehicle carcass by a vehicle manufacturer. The vehicle roof comprises a roof frame, which can be regarded as a support structure, at least in the broadest sense, and an outer roof skin element, which forms at least a part of the visible surface of the vehicle roof disposed on the outside of the respective vehicle. On the inside, i.e., on the side facing a vehicle interior, the vehicle roof has a headliner which forms the visible surface visible from the vehicle interior. For example, the outer roof skin element is formed by an at least partially transparent fixed roof element, which is engaged from beneath by the headliner only in its edge areas. Alternatively, the outer roof skin element is formed by a lid element of a roof opening system which can be displaced between a closed position closing a roof opening and an open position which opens the roof opening at least partly. In this case, the roof frame can receive parts of displacement kinematics for the lid element or be a part of the same. Furthermore, as a shading arrangement, known vehicle roofs are provided with a roller blind arrangement, which is disposed below the transparent outer roof skin element. An acoustic seal can be disposed between the roller blind arrangement and the outer roof skin element, said acoustic seal being in contact with the outer roof skin element from below via a contact surface and having a positive effect in terms of a low noise level in the vehicle interior and serving as a cover for elements of the roof frame in an open position of the shading arrangement. If no shading arrangement is provided, there is a circumferential gap between the headliner and the outer roof skin element. Through this gap, visually unappealing areas of the vehicle roof may be visible from the vehicle interior.

### SUMMARY

The object of the invention is to provide a vehicle roof of the make mentioned above which is characterized by a visually appealing appearance on its side facing the vehicle interior.

According to the invention, this object is attained by the present vehicle roof.

According to the invention, a vehicle roof is proposed which comprises a roof frame, an outer roof skin element and a headliner, which forms a visible surface visible from a vehicle interior. A gap between the outer roof skin element and the headliner is fully bridged by an acoustic seal which is in particular made of one piece. The gap between the outer roof skin element and the headliner is closed by the acoustic seal. Thus, the acoustic seal forms a visible surface which is accessible and/or visible from the inside of the roof or from the vehicle interior. This results in an aesthetically pleasing appearance in the transition area between the headliner and the outer roof skin element. Thanks to the acoustic seal designed in accordance with the invention, no further additional components are required for effectively laminating the roof frame or other roof substructure elements.

The outer roof skin element of the vehicle roof according to the invention is in particular made of an at least partially transparent fixed roof element comprising, for example, a glass window pane or a plastic window pane, said fixed roof element being rigidly or immovably disposed relative to the vehicle body. Alternatively, the outer roof skin element can also be formed by a lid element of a roof opening system, the lid element being displaceable between a closed position, in which a roof opening of the lid element is closed, and an open position, in which the roof opening is at least partly open. As a transparent surface element, the lid element can comprise a glass window pane or a plastic window pane.

In an advantageous embodiment of the vehicle roof according to the invention, the outer roof skin element comprises an in particular circumferential foamed or injection-molded mold portion, with which the acoustic seal is in contact with from below. The outer roof skin element can be mounted on the roof frame via the mold portion, in which retaining bracket or retaining plate can be molded in as inserts.

In a specific embodiment of the vehicle roof according to the invention, the acoustic seal comprises a first contact area, which rests on the outer roof skin element, and a second contact area, which rests on the headliner. Thus, the acoustic seal is molded such that two contact areas are formed, which are each in contact with the respective counter element, i.e., on the outer roof skin element or the headliner, via a contact surface. With the vehicle roof according to the invention, the acoustic seal has a contact area which is in direct contact with the headliner, preferably with an edge surface of an edgefold of the headliner or a laminating fabric of the headliner.

In particular, the two contact areas of the acoustic seal are produced integrally from the same material, for example from a foamed rubber or another elastically deformable material. Thus, there is no transition between different materials of the acoustic seal on the visible surface accessible from the vehicle interior. This has a positive effect for the appearance of the vehicle roof. For example, the contact area in contact with the outer roof skin element is made of a tube portion of the acoustic seal, which is in contact with the outer roof skin element from below, said tube portion being made of foamed rubber. The second contact area of the acoustic seal, which in particular stands on the headliner from above, can be solid and also be made of the material of the tube portion. This solid portion of the acoustic seal can be can be considered an integral extension of the tube portion. Preferably, the second contact area is directly made of the flexible component of the profile of the acoustic seal, said flexible component in particular being made of foamed rubber. This means that the acoustic seal can always be seamlessly in contact with the headliner and the outer roof skin element, compensating for tolerances, and provide a clean finish. It is conceivable that the acoustic seal is in form-fitting contact with the outer roof element and/or the headliner.

In an advantageous embodiment of the vehicle roof according to the invention, the acoustic seal is attached to the roof frame, preferably via a sealing base which engages with a counter element of the roof frame. The sealing base has a groove in which a rib of the roof frame engages which constitutes the counter element. It is also conceivable that the seal base forms a rib which engages with a groove of the roof frame.

To prevent noise from being generated when the vehicle in question is in motion due to components moving relative to each other, the contact areas of the acoustic seal are preferably provided with a lubricating varnish. Creaking sounds and the like can thus be counteracted effectively.

The vehicle roof according to the invention, is preferably configured without a mechanical shading system, such as a roller blind system. It is therefore possible that the acoustic seal is formed circumferentially and is in circumferential with the outer roof skin element from above and with the headliner from below.

Further advantages and advantageous embodiments of the subject matter of the invention can be derived from the description, the drawing and the patent claims. The invention relates to all combinations comprising at least two features disclosed in the description, the patent claims and/or the figures, i.e., each feature mentioned in the description can in itself be part of the claimed subject-matter independently of the further features and/or specifications mentioned in the respective context.

### BRIEF DESCRIPTION OF DRAWINGS

Embodiments of a vehicle roof according to the invention are illustrated schematically simplified in the drawing and are described in more detail hereinafter.

FIG. 1 shows a perspective top view of a motor vehicle having a vehicle roof according to the invention;

FIG. 2 shows a cut through the vehicle roof along line II-II in FIG. 1; and

FIG. 3 shows a cut through the vehicle roof along line III-III in FIG. 1.

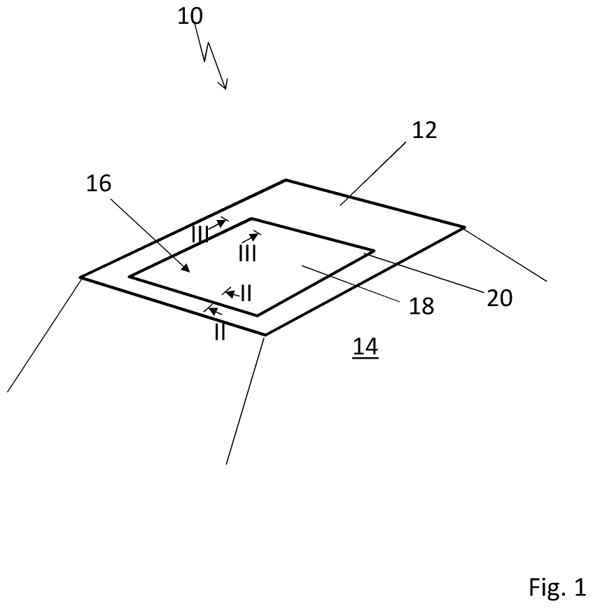

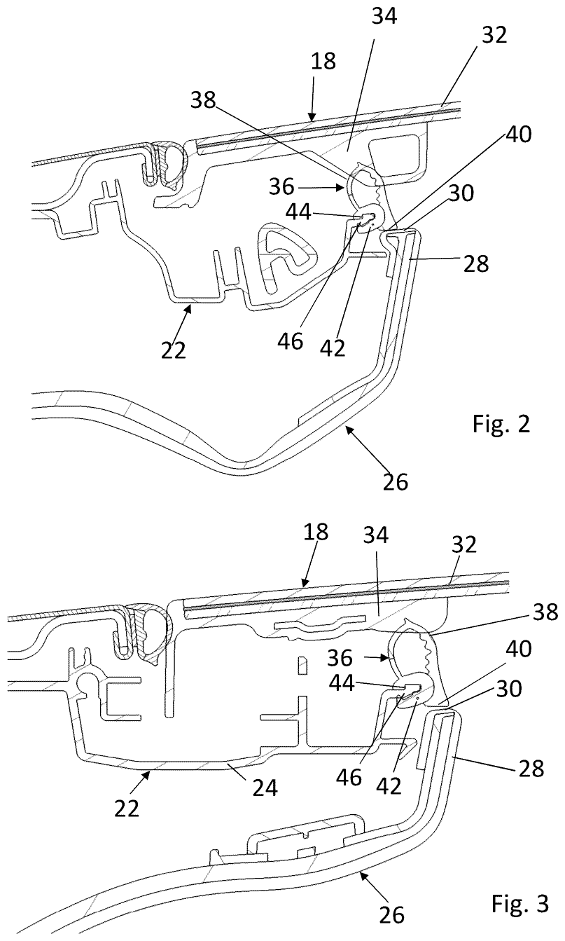

### DETAILED DESCRIPTION

The drawing shows a motor vehicle 10 which is a passenger car and has a vehicle roof 12, which covers a vehicle interior 14. Vehicle roof 12 is provided with a roof opening system 16, which is provided with a lid element 18, which is displaceable between a closed position closing roof opening 20 and an open position opening roof opening 20. Lid element 18 is an outer roof skin element which forms a visible surface visible from the vehicle exterior.

Furthermore, vehicle roof 12 comprises a roof frame 22, which forms a guide rail 24 of displacement kinematics for lid element 18 along each side rail extending in the longitudinal vehicle direction. The underside of the vehicle roof is provided with a headliner 26, which forms a visible surface of vehicle roof 12 visible from vehicle interior 14. Headliner 26 has an edgefold 28 which follows roof opening 20 circumferentially and which has an upper edge surface 30, which faces lid element 18.

Lid element 18 has a window arrangement 32, which is configured as a laminated window and which is transparent, and a mold portion 34, which is circumferentially formed or foamed on the edge area of window arrangement 32 and by means of which lid element 18 is connected to the displacement kinematics or roof frame 22. Mold portion 34 covers the circumferential edge and a circumferential edge strip of window arrangement 32 on the underside.

To bridge a gap between edge surface 30 of headliner 26 and mold portion 34 of lid element 18 in the closed position of lid element 18, vehicle roof 12 has a so-called acoustic seal 36, which circumferentially encloses roof opening 20 and abuts from below against mold portion 34 via a first contact area 38 and abuts from above against edge surface 30 of headliner 26 via a second contact area 40. Acoustic seal 36 is attached to roof frame 22.

Acoustic seal 36 is formed as a two-component extrusion part and has a seal base 42, which is formed by a first material component produced by made of solid rubber or EPDM. Seal base 42 serves to attach acoustic seal 36 on roof frame 22 and has a groove 44, which in particular has an undercut and into which a corresponding molded rib 46 of roof frame 22 engages, preferably in a form-fitting manner. First contact area 38 of acoustic seal 36 formed in the manner of a tubular seal and made of foamed rubber, which forms the second material component of acoustic seal 36. The foamed rubber extends from the tube area downward into a solid portion, which forms second contact area 40, so that the visible surface of acoustic seal 36 accessible from the vehicle interior is fully made of foamed rubber.

To prevent creaking sounds and the like, which can be an obstacle to a relative movement between lid element 18 and acoustic seal 36 and/or to a relative movement between headliner 26 and acoustic seal 36, contact areas 38 and 40 of the acoustic seal are coated with a lubricating varnish. In particular, the outer face of acoustic seal 36 can be fully coated with the lubricating varnish.

### LIST OF REFERENCE SIGNS

10 motor vehicle
12 vehicle roof
14 vehicle interior
16 roof opening system
18 lid element
20 roof opening
22 roof frame
24 guide rail
26 headliner
28 edgefold
30 edge surface
32 window arrangement
34 mold portion
36 acoustic seal
38 first contact area
40 second contact area
42 seal base
44 groove
46 rib

1. A vehicle roof, comprising:
a roof frame,
an outer roof skin element and a headliner, which forms a visible surface visible from a vehicle interior, and
an acoustic seal, which fully bridges a gap between the outer roof skin element and the headliner.

2. The vehicle roof according to claim 1, wherein the acoustic seal has a first contact area, which is in contact with the outer roof skin element, and a second contact area, which is in contact with the headliner.

3. The vehicle roof according to claim 2, wherein the acoustic seal is a two-component element and the contact areas, via which the acoustic seal is in contact with the headliner and the outer roof skin element, are formed by the same material component.

4. The vehicle roof according to claim 2, wherein at least one contact area is formed by a tube portion of the acoustic seal.

5. The vehicle roof according to claim 2, wherein at least one contact area is formed by a solid portion of the acoustic seal.

6. The vehicle roof according to claim 1, wherein the acoustic seal is attached to the roof frame and has a seal base, which is fixed to a counter element of the roof frame.

7. The vehicle roof according to claim 6, wherein the seal base has a groove, in which a rib of the roof frame engages, said rib forming the counter element.

8. The vehicle roof according to claim 1, wherein the acoustic seal is provided with a lubricating varnish which interacts with the headliner.

9. The vehicle roof according to claim 1, wherein the acoustic seal is in contact with an edge surface of an edgefold of the headliner.

10. The vehicle roof according to claim 1, wherein the acoustic seal is in contact with a foamed or injection-molded mold portion of the outer roof skin element.

11. The vehicle roof according to claim 1, wherein the acoustic seal is in circumferential contact with the outer roof skin element from below and in contact with the headliner from above.

12. The vehicle roof according to claim 1, wherein the outer roof skin element comprises an at least partially transparent window element.

13. The vehicle roof according to claim 1, wherein the outer roof skin element is a fixed roof element or a lid element of a roof opening system.
